(19) United States
(12) Patent Application Publication
(10) Pub. No.: US 2023/0320261 A1
(43) Pub. Date: Oct. 12, 2023

(54) Robotic Device with Deployable Propulsion System

(71) Applicant: Dean Solon, Portland, TN (US)

(72) Inventor: Dean Solon, Portland, TN (US)

(21) Appl. No.: 18/124,336

(22) Filed: Mar. 21, 2023

Related U.S. Application Data
(60) Provisional application No. 63/323,038, filed on Mar. 23, 2022.

(51) Int. Cl. A01D 34/00; B60K 17/354; B60K 7/00; B62D 11/04; A01D 69/02

(52) U.S. Cl. CPC A01D 34/008; A01D 69/02; B60K 7/0007; B60K 17/354; B62D 11/04; A01D 2101/00

(57) ABSTRACT

In general, the subject matter described in this disclosure can be embodied in a robotic mowing device that includes a main body, a left-side driving wheel, a right-side driving wheel, and one or more motors to drive the left-side driving wheel and the right-side driving wheel to cause the left-side driving wheel and the right-side driving wheel to turn. The robotic mowing device also includes a deployable propulsion device that includes a rolling member and that is adapted to actuate the rolling member between a deployed state in which the rolling member is adapted to contact the ground surface, and a retracted state in which the rolling member is held apart from the ground surface.

### CROSS REFERENCE TO RELATED APPLICATIONS

This application claims the benefit of priority of U.S. Provisional Application No. 63/323,038, filed on Mar. 23, 2022, which is incorporated by reference herein in its entirety.

### TECHNICAL FIELD

This document generally relates to robotic devices.

### BACKGROUND

Robotic devices can include sensor systems to sense their environments, wheels to move such devices through their environments, and computers to make decisions regarding how to move about and which actions to perform. Some robotic devices include blades to cut grass and other vegetation, and therefore operate as robotized vegetation mowers.

### SUMMARY

This document describes techniques, methods, systems, and other mechanisms that involve robotic devices with deployable vehicle propulsion systems. For example, this disclosure references robotic devices, such as robotized vegetation mowers, that can deploy an additional propulsion system when traction is sub-optimal or expected to be sub-optimal. For example, a robotic mower may include two drive wheels that are operated by one or more motors. Should the robotic mower determine that the wheels are experiencing poor traction (e.g., due to one wheel spinning faster than the other), the robotic mower can deploy an additional propulsion system to increase traction. For example, the robotic mower can lower a continuous track (e.g., a belt or collection of linked segments) on each side of the mower to provide additional traction and propulsion.

Particular implementations can, in certain instances, realize one or more of the following advantages. A robotic device with a deployable propulsion system may be less likely to get stuck and may be more able to get unstuck. Such a robotic device may use less energy than a similar robotic device in which the propulsion system is always employed, which can extend a range of the robotic device and/or enable use of a smaller battery. A deployable propulsion system can enhance stability when moving on slopes, both across slopes and when going up and down the slopes.

Including a deployable propulsion system on a robotic device can also decrease the traction requirements of the primary propulsion components (e.g., primary drive wheels that are adapted to always contact the ground surface). As such, smaller primary drive wheels, or wheels with less-aggressive traction may be used. The presence of a deployable propulsion system can also limit the amount of time that the primary propulsion components are used, therefore limiting wear on the primary propulsion components. The same is true of wear to the deployable propulsion system. Because a deployable propulsion system is not always employed, the amount of wear to such a system is reduced.

The ability to operate a robotic device on land that includes portions with poor traction can limit the extent to which the land must be reworked. For example, a field that is being graded prior to installation of solar arrays may not need as significant of grading to limit slope and/or increase drainage, because robotic mowers may be able to traverse such a field. Limiting the amount of grading decreases initial energy usage, decreases construction time, and enables solar arrays to come online at an earlier date. Similarly, the ability to navigate through regions of a field that may have sub-optimal traction (e.g., due to the presence of mud), can limit detours that would otherwise increase overall energy usage and/or that may require follow-up trips to mow vegetation detoured around.

The details of one or more implementations are set forth in the accompanying drawings and the description below. Other features, objects, and advantages will be apparent from the description and drawings, and from the claims.

### DESCRIPTION OF DRAWINGS

FIGS. 1A-B show side and top views, respectively, of a robotic mower that includes a deployable vehicle propulsion system.

FIG. 1C shows a side view of the robotic mower, in which the deployable vehicle propulsion system is deployed.

FIGS. 2A-B show mechanisms for actuating deployable propulsion systems between retracted and deployed states.

FIGS. 3A-C show robotic mowers with deployable vehicle propulsion systems located at different positions on the robotic mowers.

FIGS. 4A-B show a flowchart of a process for operating a robotic device with a deployable vehicle propulsion system.

FIG. 5 is a block diagram of computing devices that may be used to implement the systems and methods described in this document, as either a client or as a server or plurality of servers.

Like reference symbols in the various drawings indicate like elements.

### DETAILED DESCRIPTION

This document generally describes robotic devices with deployable vehicle propulsion systems. An example such device is a robotic mower that is driven by motorized wheels during typical operation, but that includes one or more deployable tracks to increase traction in certain situations (e.g., when mud is encountered).

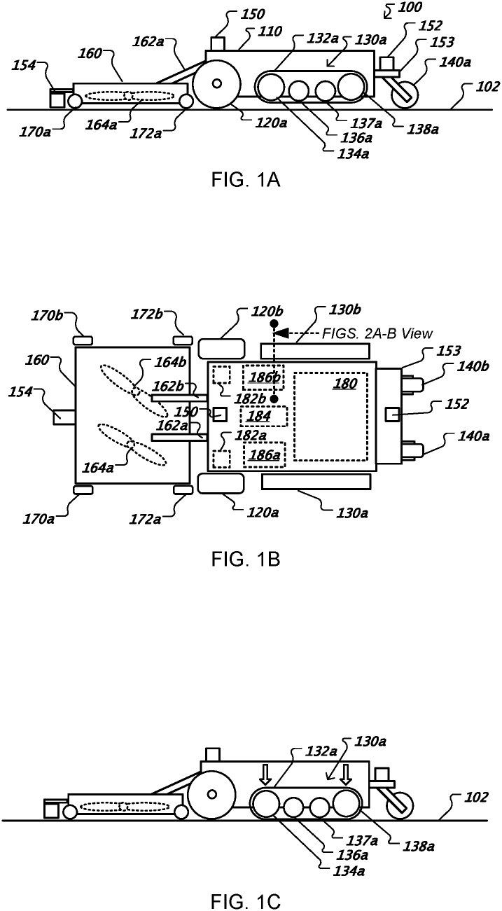

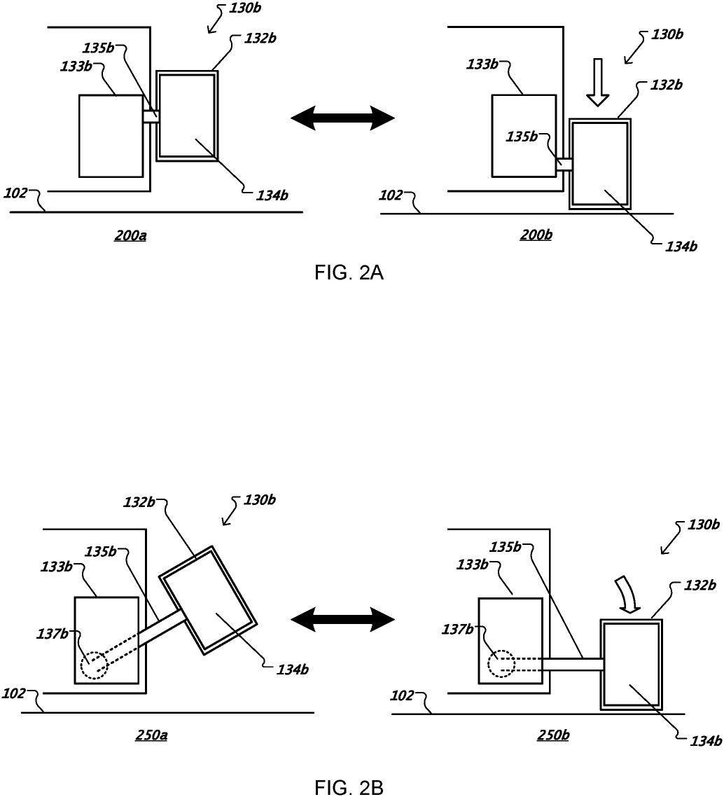

FIGS. 1A-B show side and top views, respectively, of a robotic mower 100 that includes a deployable vehicle propulsion system. The robotic device 100 includes a main body 110 that is driven by driving wheels 120a-b (e.g., a left-side driving wheel 120a and a right-side driving wheel 120b). The driving wheels 120a-b rest on a ground surface 102 when the robotic mower 100 is located on the ground surface 102 in an operable position. The main body 110 is also supported by trailing wheels 140a-b, which are attached to a bracket 153 that is attached to a rear side of the main body 110. The main body 110 houses drive motors 128a-b that are adapted to turn the driving wheels 120a-b. In some examples, a single drive motor may turn both driving wheels 120a-b. The trailing wheels 140a-b are undriven by any motor in this illustration, although the trailing wheels 140a-b may be driven by one or more motors in some implementations.

In front of the main body 110 is a vegetation cutting assembly 160. The vegetation cutting assembly 160 includes multiple blade assemblies 164a-b, with each blade assembly including multiple component blades attached to a center hub. Each of the multiple blade assemblies is driven by a motor (e.g., one of motors 182a-b, or one or more other motors not shown in FIGS. 1a-c). The vegetation cutting assembly 160 is supported above the ground surface 102 by front cutting-assembly wheels 170a-b and rear cutting-assembly wheels 172a-b. The wheels 170a-b and 172a-b are undriven in this illustration, but may be powered by motors in other examples. Linear actuators 162a-b are adapted to actuate the vegetation cutting assembly 160 between a deployed state (as shown in FIG. 1A) and a retracted state (not shown in FIGS. 1A-C). The linear actuators 162a-b can move independently, to provide height adjustability and bank angle for the vegetation cutting assembly 160.

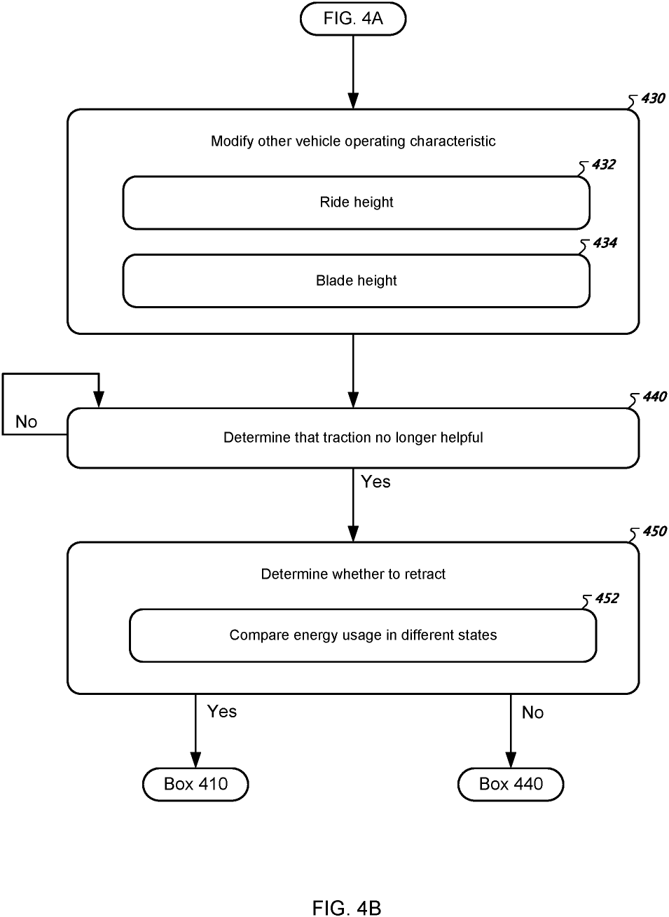

The robotic mower 100 includes multiple sensors, including a moisture sensor 154, a LIDAR sensor 150, and a camera 152. The main body 110 also houses a battery 180 to power components of the robotic mower 110, and a computerized control system 184 to analyze data retrieved from the sensors and make decisions regarding how to move the robotic mower 100 and when to rotate the blades 164a-b. The operation of the computerized control system 184, including the analysis of sensor data, is described in additional detail with respect to the flowchart of FIGS. 4A-B.

The main body 110 of the robotic mower 100 includes deployable propulsion systems 130a-b (i.e., a left-side deployable propulsion system 130a and a right-side deployable propulsion system 130b). Each of the deployable propulsion systems 130a-b includes a continuous track (e.g., track 130a) that is either a continuous belt or a collection of connected segments. Within each continuous track is multiple wheels, for example, a driving wheel 134a, road wheels 136a and 137a, and a rear wheel 138. The driving wheels are powered by motors 186a-b to turn the continuous tracks, and also support the main body 110 above the ground surface 102 (e.g., by sandwiching the continuous track 130a between the driving wheel 134a and the ground surface 102).

In some examples, the driving wheels are sprockets that are suspended above the ground surface 102 and are not adapted to contact the ground surface 102. In such examples, at least the ground wheels (e.g., 136a and 137b) are the components which contact the ground surface when the deployable propulsion systems 130a-b are deployed. The deployable propulsion systems 130a-b are illustrated in FIGS. 1A-B as including a continuous tracks as its rolling members, but the deployable propulsion systems 130a-b may alternatively each include a single driven wheel or multiple driven wheels (without a continuous track surrounding the wheels) as their rolling members.

Each of the deployable propulsion systems 130a-b is adapted to actuate between (1) a retracted state in which the continuous track is held apart from the ground surface 102 when the robotic mower 110 is located on the ground surface 102, and (2) a deployed state in which the continuous track is adapted to contact the ground surface 102 when the robotic mower 110 is located on the ground surface 102. FIG. 1A shows the robotic mower 100 with each deployable propulsion system 130a-b in its retracted state. FIG. 1C shows the robotic mower 100 with each deployable propulsion system 130a-b in the deployed state.

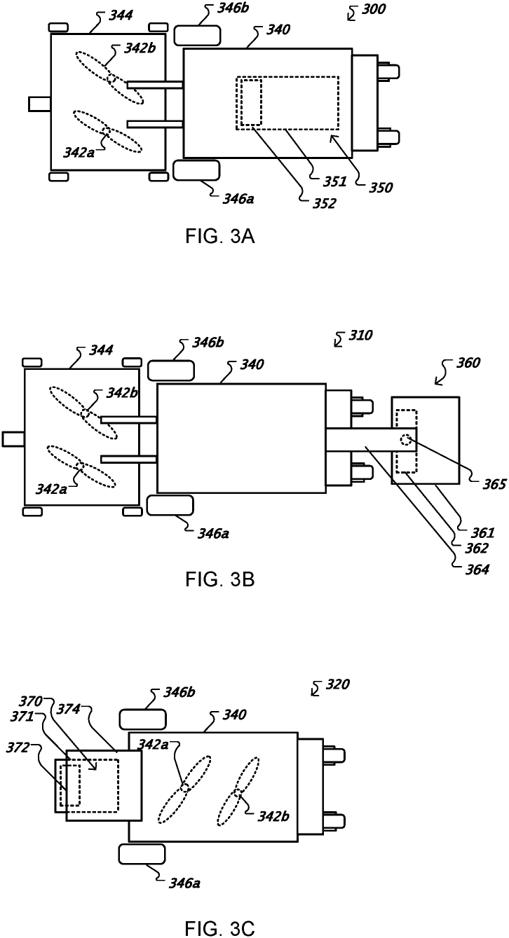

FIGS. 2A-B show different mechanisms for actuating deployable propulsion systems between retracted and deployed states. FIG. 2A shows a sectional view of a portion of the robotic mower 100 (see FIG. 1B for an indication of the position of the sectional view), in which the continuous track 132b is linearly actuated between a retracted state 200a and a deployed state 200b. The driving wheel 134b is attached to a rotatable axle 135b, which can be selectively moved up and down along a linear path by an actuating assembly 133b, in a direction that is transverse to a rotating axis of the axle 135b. The actuating assembly 133b may include the motor 186b (see FIG. 1B), or the actuating assembly 133b may serve as an interface between the motor 186b and the driving wheel 134b, with the actuating assembly 133b being adapted to transfer rotational power to the driving wheel 134b while also being able to linearly actuate the driving wheel 134b between the retracted state 200a and the deployed state 200b.

FIG. 2B shows a sectional view of the same portion of the robotic mower 100 (see FIG. 1B), in which the continuous track 132b is rotationally actuated between a retracted state 250a and a deployed state 250b (rather than linearly actuated, as with FIG. 1A). The driving wheel 134b is attached to the rotatable axle 135b, which can be selectively rotated up and down about a pivot point 137b by an actuating assembly 133b. The actuating assembly 133b may include the motor 186b (see FIG. 1B), or the actuating assembly 133b may serve as an interface between the motor 186b and the driving wheel 134b, with the actuating assembly 133b being adapted to transfer rotational power to the driving wheel 134b while also being able to rotationally actuate the driving wheel 134b between the retracted state 250a and the deployed state 250b.

While FIGS. 2A-B show sectional views of a right portion of the robotic mower 100, a corresponding left side of the robotic mower 100 includes similar components.

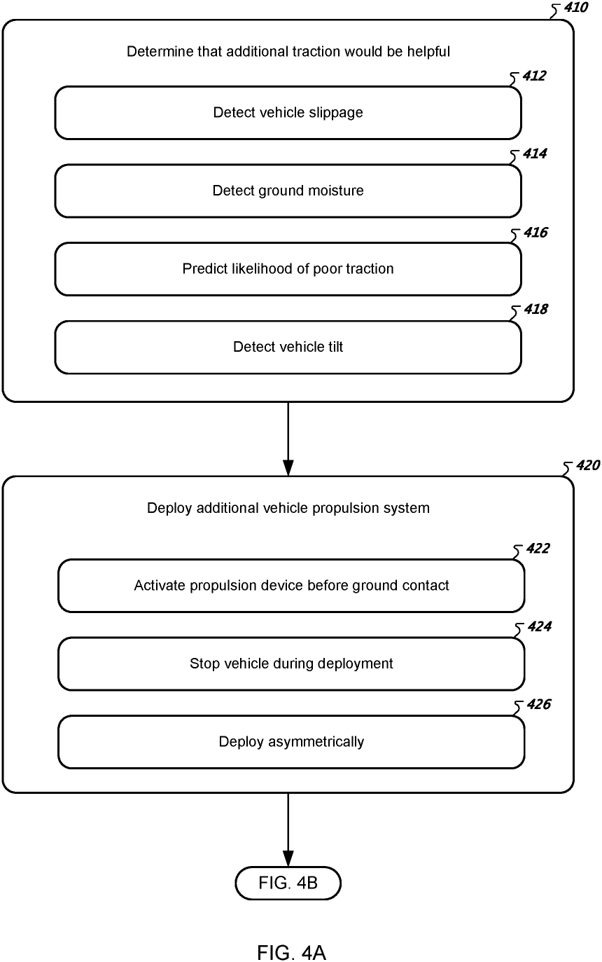

FIGS. 3A-C show robotic mowers with deployable vehicle propulsion systems located at different positions on the robotic mowers. While FIGS. 1A-C show that the deployable vehicle propulsion systems 130a-b flank the sides of the main body 110 of the robotic mower 100, similar robotic devices may include similar one or more deployable vehicle propulsion systems in different places.

For example, FIGS. 3A-C show robotic mowers 300, 310, and 320 that each include a main body 340 (similar to the main body 110, in FIGS. 1A-C), driving wheels 346a-b (similar to the driving wheels 120a-b, in FIGS. 1A-C), a vegetation cutting assembly 344 (similar to the vegetation cutting assembly 160, in FIGS. 1A-C), and blade assemblies 342a-b (similar to the blade assemblies 164a-b, in FIGS. 1A-C). A difference between the robotic mowers 300, 310, and 320 from the robotic mower 100 is that robotic mowers 300, 310, and 320 do not include deployable vehicle propulsion systems that flank the sides of the main body of the robotic mower.

FIG. 3A shows the robotic mower 300, which includes a deployable propulsion system 350 that includes a single continuous track 351 and a driving wheel 352. The deployable propulsion system is located at a bottom of the main body 340, such that the deployable propulsion system can: (1) retract the continuous track 351 (e.g., into cavity defined by an underside of the main body 340) so that the continuous track 351 is retained above a ground surface when extra traction is not needed, and (2) deploy the continuous track 351 by extending the continuous track towards the ground surface so that the continuous track 351 is in contact with the ground surface and the driving wheel 352 is actuated to turn the continuous track 351 when extra traction is needed.

FIG. 3B shows the robotic mower 310, which includes a deployable propulsion system 360 that includes a single continuous track 361 and a driving wheel 362. The deployable propulsion system 360 is located behind the robotic mower 310 and the robotic mower 310 can actuate an actuating arm 364 to move the continuous track 361 between: (1) a retracted state in which the continuous track 361 is retained in a suspended state above the ground surface, and (2) a deployed state in which the continuous track 362 is placed in contact with the ground surface and the driving wheel 362 is actuated to turn the continuous track 361.

The robotic mower 360 may include a pivoting device 365 that interfaces between the actuating arm 364 and the deployable propulsion system 361, enabling the deployable propulsion system 361 to twist and pivot (e.g., in all angles). Similarly, the actuating arm 364 may move up and down, and side to side. A combination of movement by the actuating arm 364 and the pivoting device 365 enables the robotic mower 310 to move the deployable propulsion system 361 to any of multiple positions in contact with the ground behind the main body 310, and at any of multiple angles with respect to the ground.

As just a few examples, this significant amount of movement enables the robotic mower 310 to: (1) place the propulsion system 361 to the left or right of the main body 340 to stabilize the mower 310 on slopes or avoid ground that is saturated with water, (2) angle the propulsion system to follow the contours of the ground, and (3) adjust weight distribution (e.g., by pushing the actuating arm 364 downward to limit the amount of pressure on the trailing wheels or even lift the trailing wheels off the ground). In other examples, a deployable propulsion system 360 can be placed in front of the mower, to either side of the mower, or can deploy from an arm extending from a top of the mower, to swing to any side of the mower.

FIG. 3C shows the robotic mower 320, which includes a deployable propulsion system 370 that includes a single continuous track 371 and a driving wheel 372. The deployable propulsion system 370 is located in front of the main body 340, with the blade assemblies 342a-b being located under the main body 430 of the robotic mower 320. The robotic mower 320 can actuate an actuating component (not shown) to move the continuous track 371 between: (1) a retracted state in which the continuous track 371 is retained in a suspended state above the ground surface, and (2) a deployed state in which the continuous track 372 is placed in contact with the ground surface and the driving wheel 372 is actuated to turn the continuous track 371.

Although FIGS. 1A-C and 3A-B show blade assemblies located in front of the main bodies of the respective robotic mowers, the blade assemblies may be located under the main body of the respective robotic mowers, as illustrated in FIG. 3C, or behind the main body of the respective robotic mowers in a towed configuration.

Although FIGS. 3A-C each shows a single continuous track, the robotic mowers 300, 310, and 320 may each include multiple deployable continuous tracks located in similar positions, one or more deployable driving wheels located in similar positions, and/or a combination of both one or more deployable continuous tracks and one or more deployable driving wheels located in similar positions.

FIGS. 4A-B show a flowchart of a process for operating a robotic device with a deployable vehicle propulsion system.

At box 410, a computing system (e.g., the computerized control system 184, a remote computing system communicating wirelessly with the computerized control system 184, or a combination of both) determines that a robotic mower (e.g., robotic mower 100, 300, 310, or 330) should use additional traction. The determination to use additional traction can be a determination to deploy an additional vehicle propulsion system.

At box 412, the determination to use additional traction can be based on detecting vehicle slippage. For example, sensors may analyze a speed of rotation of each driven wheel. Should the computing system determine that driven wheels are turning at different rates (e.g., by a margin that exceeds a threshold), the computing may determine to use additional traction. This can be because wheels turning at different rates can indicate that one or both wheels have lost traction. Another example involves comparing a speed of rotation of one or more driven wheels to a speed of rotation of one or more undriven wheels. A driven wheel and an undriven wheel turning at different rates can indicate slippage and therefore poor traction.

At box 414, the determination to use additional traction can be based on detecting ground moisture. For example, the moisture sensor 154 may analyze the ground in front of the mower 100 as the mower moves forward (e.g., from right to left in FIG. 1A) to determine a moisture content in front of the mower. The moisture sensor 154 can do so by analyzing electromagnetic signals bounced off the ground and/or by placing probes into the ground surface. Should the moisture content exceed a threshold level (e.g., for a duration in distance or time that exceeds a threshold duration), the computing system may determine that additional traction should be used, based on the likelihood of slippage.

At box 416, the determination to use additional traction can be based on a predicted likelihood of poor traction in a certain region. For example, the computing system may analyze sensor data (e.g., LIDAR and/or photographical data) obtained by the sensors 150 and 152, and/or ground or flying robotic drones, to determine that certain regions of a surveyed field either have or are likely to have standing water or a ground saturation content that exceeds a certain threshold. Such sensor data may be fed into an analytical software program (e.g., a machine learning model) along with historical weather data (e.g., recent precipitation records) to classify regions of the field as likely providing poor traction.

A robotic mower may navigate the field on pre-planned routes, using Simultaneous localization and mapping (SLAM) processes involving data captured by the sensors 150 and 152, to perform local object avoidance and to update maps of the field. Upon the robotic mower coming upon a region classified as likely providing poor traction, the robotic mower may pre-emptively determine to use additional traction.

At box 418, the determination to use additional traction can be based on the robotic mower determining that the mower has tilted a threshold amount (e.g., 20% or more to the side, or 30% or more forward or backward). The determination can also be performed upon the mower moving into a region of the field that is designated by a model of the field as having a level of tilt that exceeds a threshold.

At box 420, the robotic mower deploys an additional vehicle propulsion system. For example, the robotic mower 100 may actuate its vehicle propulsion systems 130a-b to move from: (1) a retracted state in which a rolling member of each vehicle propulsion system is held apart from the ground surface (as shown in FIG. 1A); to (2) a deployed state in which the rolling member is adapted to contact the ground surface (e.g., as illustrated in FIG. 1C).

At box 422, the robotic mower performs operations to activate the propulsion systems before ground contact. For example, the computerized control system 184 can activate the motors 184a-b, turning the driving wheels 134a-b while the driving wheels 134a-b are being lowered to the ground surface. This simultaneous movement of the driving wheels 134a-b (both rotating and lowering), occurring at the same time that the driving wheels 120a-b turn, can ensure that the continuous tracks 132a-b are moving when they comes into contact with the ground, so that the continuous tracks 132a-b assist traction rather than hindering traction.

At box 424, in some examples, the robotic mower stops the vehicle while the vehicle propulsion systems are deployed. For example, upon determining that additional traction should be used, the robotic mower 100 may: (1) stop the driving wheels 120a-b, (2) lower the deployable propulsion systems 130a-b, and (3) begin turning the driving wheels 120a-b and the driving wheels 134a-b at the same time to move the robotic mower 100 forward with additional traction.

At box 426, in some examples, the robotic mower deploys the propulsion systems asymmetrically. For example, in situations in which the robotic mower 100 is moving sideways across a slope and is tilted to the left by thirty degrees, the computing system may determine to deploy only the left-side deployable traction system 130a. This asymmetric deployment may be performed because deploying a single side may save energy usage with respect to deploying both sides, and because deploying a single deployable propulsion system on the downhill side may be sufficient to ensure stability and adequate traction for the robotic mower 100 (e.g., because more than half of the weight of the robotic mower 100 may bear on the left side of the robotic mower 100).

At box 430, the computing system may modify another vehicle operating characteristic, in addition to deploying a vehicle propulsion system, as a result of determining to use additional traction. For example, the determination that additional traction is needed can be a result of determining that there is excessive moisture (e.g., mud is present). As such, the robotic mower 100 may settle into the ground more, and the robotic mower 100 may increase the ride height (box 432) and/or increase the blade height (box 434) so that the mower underbody and/or blades are less likely to come into contact with mud.

Conversely, responsive to such a determination that additional traction is need, the robotic mower 100 may decrease the ride height (box 432) and/or decrease the blade height (box 434), because the deployment of the additional vehicle propulsion systems 130a-b may ensure that the robotic mower 100 sits atop the ground surface. In another example, the computing system may stop turning the blades responsive to such a determination, because it may be undesirable to mow vegetation while the soil in which it is growing is saturated with water.

At box 440, the computing system determines that traction is no longer helpful. For example, the event that caused the computing system to determine at box 410 that the robotic mower should use additional traction may end. For example, there may be no detectable vehicle slippage for a period of time that extends past a threshold duration (see box 412). Or the moisture sensor 154 may not detect an excessive level of moisture for a certain duration of time (see box 414). Or the robotic mower may have moved past a patch that the model of the field designates as wet (see box 416). Or the robotic mower may tilt back to within levels for which additional traction is unnecessary (see box 418). The determination that traction is no longer needed may be based on any one or a combination of these factors and other factors.

As denoted by the “No” branch of box 440, the computing system may continue to operate with the propulsion system deployed until the determination of box 440 is that such additional traction is no longer needed.

At box 450, should the computing system determine that additional traction is no longer helpful (as discussed above), the computing system may perform an additional determination regarding whether to retract the propulsion system. This additional determination may be based determining how soon the propulsion system is likely to be deployed again (e.g., based on a model of the field and anticipated field characteristics ahead in a path being travelled by the robotic mower).

At box 452, the computing system may compare energy usage in different states, for example, by: (1) computing an expected energy usage to retract the propulsion system and then deploy the propulsion system when needed again, (2) computing an expected energy usage to continue to turn a drive wheel of the propulsion system until the propulsion system is again expected to be deployed, and (3) comparing the expected energy usage in each state to select the state that uses the least amount of energy.

Should the computing system determine to retract the propulsion system, the robotic mower may retract the propulsion system and continue to proceed upon its current path until the computing system again determines that additional traction should be employed (by again performing the operations of box 410).

Should the computing system determine to not retract its propulsion system, the robotic mower may continue to proceed along its path with its propulsion system deployed, both up to and through the next patch that requires additional traction, until the computing system again determines that additional traction is no longer helpful (by again performing the operations of box 440).

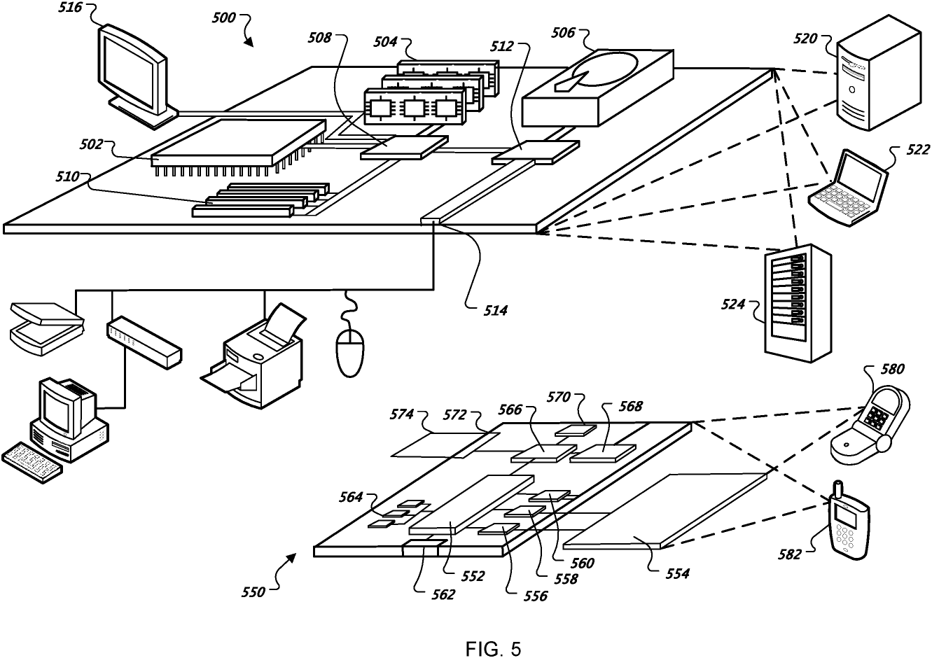

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be examples only, and are not meant to limit implementations described and/or claimed in this document.

Computing device 500 includes a processor 502, memory 504, a storage device 506, a high-speed controller 508 connecting to memory 504 and high-speed expansion ports 510, and a low speed controller 512 connecting to low speed expansion port 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high-speed controller 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high-speed controller 508 manages bandwidth-intensive operations for the computing device 500, while the low speed controller 512 manages lower bandwidth-intensive operations. Such allocation of functions is an example only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. Additionally, the processor may be implemented using any of a number of architectures. For example, the processor may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provided, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552 that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Additionally computing device 500 or 550 can include Universal Serial Bus (USB) flash drives. The USB flash drives may store operating systems and other applications. The USB flash drives can include input/output components, such as a wireless transmitter or USB connector that may be inserted into a USB port of another computing device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for performing the systems and methods described in this document may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A robotic mowing device, comprising:
a main body;
a left-side driving wheel attached at a left side of the main body and adapted to contact a ground surface when the robotic mowing device is located on the ground surface;
a right-side driving wheel attached to a right side of the main body and adapted to contact the ground surface when the robotic mowing device is located on the ground surface;
one or more motors to drive the left-side driving wheel and the right-side driving wheel to cause the left-side driving wheel and the right-side driving wheel to turn;
a deployable propulsion device that includes a rolling member and that is adapted to actuate the rolling member between:
(i) a deployed state in which the rolling member adapted to contact the ground surface when the robotic mowing device is located on the ground surface; and
(ii) a retracted state in which the rolling member is held apart from the ground surface when the robotic mowing device is located on the ground surface.

2. The robotic mowing device of claim 1, wherein the rolling member comprises a continuous track and multiple wheels positioned within the continuous track.

3. The robotic mowing device of claim 2, wherein:
the deployable propulsion device is a left-side deployable propulsion device and the rolling member is a left-side rolling member; and
the robotic mowing device comprises a right-side deployable propulsion device that includes a right-side rolling member and that is adapted to actuate the right-side rolling member between:
(i) a right-side deployed state in which the right-side rolling member is in contact with the ground surface when the robotic mowing device is located on the ground surface; and
(ii) a right-side retracted state in which the right-side rolling member is held apart from the ground surface when the robotic mowing device is located on the ground surface.

4. The robotic mowing device of claim 3, comprising:
a left-side trailing wheel that is adapted to contact the ground surface and that is spaced apart from the left-side driving wheel; and
a right-side trailing wheel that is adapted to contact the ground surface and that is spaced apart from the right-side driving wheel.

5. The robotic mowing device of claim 4, wherein:
the left-side trailing wheel is undriven by any motor; and
the right-side trailing wheel is undriven by any motor.

6. The robotic mowing device of claim 4, wherein:
the left-side deployable propulsion device is located between the left-side driving wheel and the left-side trailing wheel; and
the right-side deployable propulsion device is located between the right-side driving wheel and the right-side trailing wheel.

7. The robotic mowing device of claim 6, comprising:
a vegetation-cutting assembly that is attached to the main body and that includes a blade that is adapted to cut vegetation;
the left-side driving wheel is located between the vegetation-cutting assembly and the left-side deployable propulsion device; and
the right-side driving wheel is located between the vegetation-cutting assembly and the right-side deployable propulsion device.
